(19) United States
(12) Patent Application Publication
(10) Pub. No.: US 2013/0040201 A1
(43) Pub. Date: Feb. 14, 2013

(54) HIGH CAPACITY LAYERED OXIDE CATHODS WITH ENHANCED RATE CAPABILITY

(71) Applicants: Arumugam Manthiram, Austin, TX (US); Jun Liu, Newark, DE (US); Baby Reeja Jayan, Austin, TX (US)

(72) Inventors: Arumugam Manthiram, Austin, TX (US); Jun Liu, Newark, DE (US); Baby Reeja Jayan, Austin, TX (US)

(21) Appl. No.: 13/577,399

(22) PCT Filed: Mar. 2, 2011
(86) PCT No.: PCT/US11/26776

§ 371 Date: Oct. 22, 2012

Related U.S. Application Data
(60) Provisional application No. 61/310,194, filed on Mar. 3, 2010.

(51) Int. Cl. H01M 4/131

(52) U.S. Cl. 429/223; 429/224; 429/231.3

(57) ABSTRACT

The present invention provides a surface modified cathode and method of making surface modified cathode with high discharge capacity and rate capability having a lithium-excess Li[M_{1-y}Li_{y}]O₂ (M=Mn, Co, and Ni or their combinations and 0<y≦0.33) cathode surface with a surface modification comprising lithium-ion coated sample conductor, or an electronic conductor, or a mixed lithium-ion and electronic conductor to suppress the elimination of oxide ion vacancies, reduce the solid-electrolyte interfacial (SEI) layer thickness, reduce the irreversible capacity loss in the first cycle, and enhance the rate capability.

### STATEMENT OF FEDERALLY FUNDED RESEARCH

This invention was made with U.S. Government support from NASA NNC09CA08C. The government has certain rights in this invention.

### TECHNICAL FIELD OF THE INVENTION

The present invention relates in general to the field of electrodes, specifically to compositions of matter and methods of making and using high capacity layered oxide cathodes with enhanced rate capability.

### CROSS-REFERENCE TO RELATED APPLICATIONS

None.

### INCORPORATION-BY-REFERENCE OF MATERIALS FILED ON COMPACT DISC

None.

### BACKGROUND OF THE INVENTION

Without limiting the scope of the invention, its background is described in connection with high capacity layered oxide cathodes with enhanced rate capability. Lithium ion battery technology has played a key role in the portable electronics revolution, and it is vigorously pursued for vehicle applications. However, the presently available cathodes have limited capacity (<200 mAh/g). Lithium ion batteries offer the highest energy density among the known rechargeable battery systems, and as a result, there is enormous interest to increase the energy density further. In this regard, solid solutions between Li[Li_{1/3}Mn_{2/3}]O₂ and LiMO₂ (M=Ni, Co, Mn) have been found recently to offer much higher capacity with a significant reduction in cost and improvement in safety compared to the commercially used layered LiCoO₂.¹⁻⁶ For example, these “lithium excess” layered compositions like Li[Li_{0.2}Mn_{0.54}Ni_{0.13}Co_{0.13}]O₂ exhibit capacities of as high as about 250 mAh/g.^{7,8} The high capacities of these solid solutions have been attributed to the irreversible loss of oxygen from the lattice during the first charge and the consequent lowering of the oxidation state of the transition metal ions at the end of first discharge.^{9,10} However, these high capacity layered cathodes suffer from huge irreversible capacity Cᵢᵣᵣ loss in the first charge-discharge cycle and poor rate capability, limiting their adoptability for vehicle applications. The huge Cᵢᵣᵣ loss has been attributed to both the elimination of oxide ion vacancies from the layered lattice at the end of first charge¹¹ and side reactions with the electrolyte at the high operating voltages of up to 4.8 V.¹² The poor rate capability could be related to the low electronic conductivity associated with the Mn⁴⁺ ions and the thick solid-electrolyte interfacial (SEI) layer formed by a reaction of the cathode surface with the organic electrolytes.¹³

One possible strategy to reduce the thickness of the SEI layer is to coat the cathode surface with other inert oxides; however, most of the surface modification materials act only as a protection layer while decreasing the surface electronic conductivity of the cathode. Although surface modification with carbon is quite effective in increasing the surface conductivity of LiFeuPO₄, surface modification of the Li[Li_{1/3}Mn_{2/3}]O₂—Li[Mn,Ni,Co]O₂ solid solutions with carbon, which involves firing at higher temperatures (about 700° C.), could result in a reduction of the higher valent Mn⁴⁺ and Co³⁺ ions.

Another approach to suppress the SEI layer thickness and enhance the surface conductivity is to modify the cathode surface with conductive agents. Among the various coating agents, Al₂O₃ facilitates lithium-ion diffusion by forming LiAl₁₋ₓMO₂ (M=Mn, Co, and Ni) but hinders electron migration; RuO₂ is effective in enhancing surface electronic conductivity, but causes side reaction at the high operating voltage. Al improves the surface electronic conductivity without introducing side reactions, but the coating layer is too dense to facilitate easy lithium-ion diffusion.

### SUMMARY OF THE INVENTION

The invention is the development of a process and modification of the surfaces of the material powder and/or fabricated electrode to enhance the charge-discharge rates significantly, reduce the irreversible capacity loss in the first cycle, and increase the discharge capacity. The capacity of most of the cathode materials used in current lithium ion batteries is limited to <200 mAh/g. These difficulties have generated interest in alternative cathode materials. In this regard, layered oxides with the general formula Li[M_{1-y}Li_{y}]O₂ (M=Mn, Co, and Ni or their combinations and 0<y≦0.33) have become appealing as they exhibit capacity values of about 250 mAh/g with a lower cost. However, these high capacity layered oxides have the drawback of low charge-discharge rate capability and huge irreversible capacity loss (50-100 mAh/g) in the first cycle. The invention described here increases the rate capability, reduces the irreversible capacity loss, and offers discharge capacity values close to 300 mAh/g by surface modification of the material powder or fabricated electrode by novel processes. The surface modifications suppress the reaction between the cathode surface and the electrolyte, optimize the solid-electrolyte interface (SET) layer, enhance the surface or interfacial electronic and lithium-ion conduction, and thereby increase the charge-discharge rate and reduce the irreversible capacity loss. Lithium-ion cells fabricated with the surface modified layered oxide cathodes described here can be used for portable electronic devices; hybrid electric vehicles, and electric vehicles. In addition to providing high capacity, these cathodes significantly reduce the cost and offer improved safety.

The present invention provides devices and compositions to enhance the electrochemical performances of the high capacity layered oxide solid solution Li[Li_{0.2}Mn_{0.54}Ni_{0.13}Co_{0.13}]O₂ cathode, its surface has been modified with 2 wt. % Al₂O₃, 2 wt. % RuO₂, and 1 wt. % Al₂O₃+1 wt. % RuO₂. The surface modified samples exhibit much improved electrochemical performances, particularly the 1 wt. % Al₂O₃+1 wt. % RuO₂ coated sample exhibiting the highest discharge capacity and rate capability. Specifically, the Al₂O₃+RuO₂ coated sample delivers about 280 mAh/g at C/20 rate with a capacity retention of 94.3% in 30 cycles and about 160 mAh/g at 5 C rate.

The present invention provides electrode films fabricated with the high capacity layered oxide Li[Li_{0.2}Mn_{0.54}Ni_{0.13}Co_{0.13}]O₂ that have been surface modified with metallic aluminum by a thermal evaporation process including resistive evaporation or thermal resistance evaporation.

Compared to the bare Li[Li_{0.2}Mn_{0.54}Ni_{0.13}Co_{0.13}]O₂ cathode, the Al-coated cathodes (coating time ≦30 s) exhibit higher discharge capacity with lower irreversible capacity loss, better cyclability, and higher rate capability. Specifically, the 20 s Al-coated cathode exhibits the highest capacity (278 mAh/g at C/20 rate) and the best rate capability (157 mAh/g at 5 C rate), while the 30 s Al-coated cathode displays the best cyclability (268 mAh/g with a capacity retention of 98% in 50 cycles).

The present invention provides surface modification with Al of the electrode films fabricated with the layered oxide Li[Li_{0.2}Mn_{0.54}Ni_{0.13}Co_{0.13}]O₂, which belongs to the z (1−z) Li[Li_{1/3}Mn_{2/3}]O₂−z Li[Mn_{1/3}Ni_{1/3}Co_{1/3}]O₂ system with z=0.4. The surface modification of the electrode films with Al was carried out by a thermal evaporation process.

The present invention provides electrodes fabricated with the layered Li[Li_{0.2}Mn_{0.54}Ni_{0.13}Co_{0.13}]O₂ that have been coated with carbon by a thermal evaporation process including resistive evaporation or thermal resistance evaporation and characterized. The carbon coating enhances the sample surface conductivity by 40% without degrading the layered oxide. The carbon-coated cathodes exhibit much improved rate capability and cycling performance than the bare cathode.

The present invention provides a surface modified cathode with high discharge capacity having a lithium-excess Li[M_{1-y}Li₃]O₂ (M=Mn, Co, and Ni or their combinations and 0<y≦0.33) cathode surface having a surface modification comprising lithium-ion conductor, or an electronic conductor, or a mixed lithium-ion and electronic conductor to suppress the elimination of oxide ion vacancies, reduce the solid-electrolyte interfacial (SEI) layer thickness, reduce the irreversible capacity loss in the first cycle, and enhance rate capability.

The surface modification materials that enhance lithium-ion conduction are Al₂O₃ by forming layered Li₁₋ₓAl_{1-y}M_{y}O₂ or defect spinel Li₁₋ₓAl_{1-y-η}M_{y η}O₂ at the interface and AlPO₄ by forming olivine Li₁₋ₓAl_{1-y}M_{y}PO₄ at the interface. The surface modification materials that enhance electronic conduction are nanostructured M′O_{z} or A_{ζ}M′O_{z} (M′=Ti, V, Nb, Mo, W, or Ru and A=Li, Na, or K). The surface modification materials that enhance both lithium-ion conduction and electronic conduction are a combination of materials are Al₂O₃ by forming layered LiₓAl_{1-y}M_{y}O₂ or defect spinel LiₓAl_{3-y-η}M_{y η}O₄ at the interface and AlPO₄ by forming olivine LiₓAl_{1-y}M_{y}PO₄ at the interface. The Al composition includes Al₂O₃ and the Ru composition includes RuO₂.

The present invention includes a surface modification for a lithium-excess Li[M_{1-y}Li_{y}]O₂ (M=Mn, Co, and Ni or their combinations and 0<y≦0.33) cathode comprising a surface coating of a mixture of Al₂O₃ and RuO₂. The present also invention includes a method of making a surface modified cathode with an increased discharge capacity by adding an Al composition to a layered oxide composition; adding a Ru composition to the layered oxide composition; precipitating the surface modified cathode composition; and drying the surface modified cathode composition to form a Al₂O₃ and RuO₂ surface modified cathode. The Al composition includes AlNO₃ and the Ru composition includes RuCl₃. The coating material includes between 0.5 and 10 wt. %. The coating material includes about 2 wt. %. The surface modification material is Al or C. The surface modification Al or C is applied by a thermal evaporation process to the electrode film fabricated with the lithium-excess Li[M_{1-y}Li_{y}]O₂ (M=Mn, Co, and Ni or their combinations and 0<y≦0.33) cathode.

The present invention also provides the fabrication of electrode film by mixing the lithium-excess Li[M_{1-y}Li_{y}]O₂ powder, conductive carbon, and PVDF binder in a solvent; coating the mixture on a substrate; drying the mixture to form a Li[M_{1-y}Li_{y}]O₂ cathode; and depositing an aluminum or carbon coating on the Li[M_{1-y}Li_{y}]O₂ cathode.

The present invention also provides an Al coated cathode with an increased discharge capacity having a lithium-excess Li[M_{1-y}Li_{y}]O₂ (M=Mn, Co, and Ni or their combinations and 0<y≦0.33) cathode film surface having an Al coating deposited thereon to suppress the elimination of oxide ion vacancies and enhance the discharge capacity and rate capability. The Al composition coating includes a layer having a thickness from 0.1 nm to 100 nm. The Al composition coating was deposited for between 0.1 s and 600 s.

The present invention also provides a carbon coated cathode with an increased discharge capacity having a lithium-excess Li[M_{1-y}Li_{y}]O₂ (M=Mn, Co, and Ni or their combinations and 0<y≦0.33) cathode surface having a carbon composition coating deposited thereon to suppress the elimination of oxide ion vacancies and enhance the discharge capacity and rate capability.

### BRIEF DESCRIPTION OF THE DRAWINGS

For a more complete understanding of the features and advantages of the present invention, reference is now made to the detailed description of the invention along with the accompanying figures and in which:

FIG. 1 is a plot of the XRD patterns of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples.

FIG. 2 is a series of high resolution TEM images of 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples at different magnifications.

FIG. 3 is a series of plots showing the first charge-discharge curves of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples.

FIG. 4 is a plot of the cycling performance of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples.

FIG. 5 is a series of plots showing the discharge profiles of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples at various C rates.

FIG. 6 is a plot of the comparison of the rate capabilities of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples.

FIG. 7A is a schematic of the equivalent circuit and FIG. 7B is a plot of the electrochemical impedance spectra (EIS) of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples.

FIG. 8 is a series of plots showing the X-ray photoelectron spectroscopy (XPS) data of 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂: (a) Al 2p spectrum of 2 wt. % Al₂O₃ coated sample, (b) Ru 3p spectrum of 2 wt. % RuO₂ coated sample, and (c) Al 2p spectrum and (d) Ru 3p spectrum of 1 wt. % Al₂O₃+1 wt. % RuO₂ coated sample.

FIG. 9 is a series of plots showing the F 1s XPS data of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples at different sputtering times after 30 charge-discharge cycles.

FIG. 10 is a plot of the variations of the normalized LiF concentration with sputtering time for the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples.

FIGS. 11A-11J are scanning electron microscopy (SEM) images of (a) & (b) the bare, (c) & (d) 10 s Al-coated, (e) & (f) 20 s Al-coated, (g) & (h) 30 s Al-coated, and (i) & (j) 60 s Al-coated Li[Li_{0.2}Mn_{0.54}Ni_{0.13}Co_{0.13}]O₂.

FIG. 12 is a plot of the first charge-discharge curves of the bare and 10, 20, 30, and 60 s Al-coated Li[Li_{0.2}Mn_{0.54}Ni_{0.13}Co_{0.13}]O₂ cathodes.

FIG. 13 is a plot of the cycling performance of the bare and 10, 20, 30, and 60 s Al-coated Li[Li_{0.2}Mn_{0.54}Ni_{0.13}Co_{0.13}]O₂ cathodes.

FIG. 14 is a series of plots showing the discharge profiles of the bare and 10, 20, and 30 s Al-coated Li[Li_{0.2}Mn_{0.54}Ni_{0.13}Co_{0.13}]O₂ cathodes at various C rates.

FIG. 15 is a plot of the normalized capacity vs. rate curves of the bare and 10, 20, and 30 s Al-coated Li[Li_{0.2}Mn_{0.54}Ni_{0.13}Co_{0.13}]O₂ cathodes.

FIG. 16 is a plot of the variation of the surface conductivity of the Li[Li_{0.2}Mn_{0.54}Ni_{0.13}Co_{0.13}]O₂ electrodes with Al-coating time.

FIG. 17 is a plot of the EIS of the bare and 10, 20, and 30 s Al-coated Li[Li_{0.2}Mn_{0.54}Ni_{0.13}Co_{0.13}]O₂ cathodes.

FIG. 18 is of the XRD patterns of the bare and the carbon-coated Li[Li_{0.2}Mn_{0.54}Ni_{0.13}Co_{0.13}]O₂.

FIGS. 19A-19D are SEM images where (a) SEM image of the bare Li[Li_{0.2}Mn_{0.54}Ni_{0.13}Co_{0.13}]O₂ particle, (b) SEM image of the carbon-coated Li[Li_{0.2}Mn_{0.54}Ni_{0.13}Co_{0.13}]^{O}₂ particle, (c) STEM image of the carbon coated Li[Li_{0.2}Mn_{0.54}Ni_{0.13}Co_{0.13}]^{O}₂ particle, and (d) carbon map of the particle in the STM image.

FIGS. 20A-20D are plots where (a) is a plot of the discharge profiles at various C rates, (b) is a plot of the variation of discharge capacity with C rate, (c) is a plot of the cycling performance at 2C charge-discharge rate, and (d) is EIS plots of the bare and the carbon-coated Li[Li_{0.2}Mn_{0.54}Ni_{0.13}Co_{0.13}]O₂.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

One possible strategy to reduce the irreversible capacity loss (Cᵢᵣᵣ) value is surface modification of the cathodes that can suppress the fast elimination of oxide ion vacancies and significantly reduce the contact between the active material and the electrolyte.^{12,14} A lot of materials such as Al₂O₃,^{12,13} ZnO,¹⁵ MgO,¹⁶ SnO₂,¹⁷ TiO₂,¹⁸ ZrO₂,¹⁹ and AlPO₄,^{14,20} have been pursued for the surface modification of the cathodes and thereby to improve their electrochemical performances. However, most of the modification materials mainly work as a protection layer. Interestingly, certain functional surface modifications are known to enhance surface lithium ion diffusion or surface electronic conductivity. For example, Al₂O₃ modification on 5 V spinel cathodes¹³ facilitates surface lithium-ion diffusion. Similarly, carbon^{21,22} and RuO₂²³ modifications on LiFePO₄ enhance surface electronic conductivity. We have shown that surface modification of Li[Li_{0.2}Mn_{0.54}Ni_{0.13}Co_{0.13}]O₂ with Al₂O₃ reduces the Cᵢᵣᵣ value and increases the discharge capacity due to the suppression of the elimination of oxide ion vacancies. We present here the surface modification of Li[Li_{0.2}Mn_{0.54}Ni_{0.13}Co_{0.13}]O₂ with a mixture of Al₂O₃ and RuO₂ to improve both the surface lithium ion and electronic conductivities and thereby to improve the rate capability. For a comparison, surface modifications with Al₂O₃ alone and RuO₂ alone are also presented. The bare and surface modified samples are characterized by X-ray diffraction (XRD), high resolution transmission electron microscopy (TEM), charge-discharge measurements, electrochemical impedance spectroscopy (EIS), and X-ray photoelectron spectroscopy (XPS) to develop an in-depth understanding of the different coating materials.

Layered Li[Li_{0.2}Mn_{0.54}Ni_{0.13}Co_{0.13}]O₂ was synthesized by a coprecipitation method. The procedure involved first the coprecipitation of the hydroxide precursors by adding drop by drop a solution containing required amounts of manganese, nickel, and cobalt acetates into a 2 M KOH solution under stirring, washing the precipitate with de-ionized water to remove the residual KOH, followed by firing the oven-dried hydroxide coprecipitate with a required amount of LiOH.H₂O at 900° C. in air for 24 hour with a heating rate of 2° C./min and cooling rate of 5° C./min.

Surface modifications of the layered Li[Li_{0.2}Mn_{0.54}Ni_{0.13}Co_{0.13}]O₂ with Al₂O₃ alone and RuO₂ alone were carried out by first mixing AlNO₃.9H₂O or RuCl₃.3H₂O with the layered oxide, followed by adding NH₄OH solution, washing the precipitates with de-ionized water, and drying at 100° C. overnight. Surface modification of the layered oxide with a mixture of Al₂O₃+RuO₂ was carried out by a coprecipitation method similar to the one used for the preparation of the hydroxide precursors of the layered oxide cathode. Briefly, the procedure involves adding the layered oxide powder into a 3 M KOH solution under stirring, followed by adding drop by drop a solution containing required amounts of AlNO₃.9H₂O and RuCl₃.3H₂O, adjusting the pH value to about 10 with dilute HNO₃ solution, and drying the washed precipitate at 100° C. overnight. All surface modified samples were then heat treated at 450° C. in air for 3 hour to obtain the desired functional surface modification layer. The total amount of the coating material (including the total weight of Al₂O₃ and RuO₂) was fixed at 2 wt. % for all the surface modified samples. In the case of Al₂O₃+RuO₂ modified sample, Al₂O₃ and RuO₂ were 1 wt. % each.

XRD patterns were recorded with a Phillips X-ray diffractometer with Cu Kα radiation between 10° and 80° at a scan rate of 0.01°/s. TEM data were collected with a JEOL 2010F equipment to assess the microstructures of the surface modified samples. XPS data were collected at room temperature with a Kratos Analytical Spectrometer and monochromatic Al Kα (1486.6 eV) X-ray source to assess the chemical state of the coating elements on the surface modification layers. Multiplex spectra of various photoemission lines were collected at medium resolution using an analyzer pass energy of 40 eV at 0.1 eV step and an integration interval of 1 s/eV. All spectra were calibrated with the C is photoemission peak at 285.0 eV to account for the charging effect.

Electrochemical performances were evaluated with CR2032 coin cells between 4.8 and 2.0 V. The cathodes were prepared by mixing 75 wt. % active material with 20 wt. % acetylene black and 5 wt. % PTFE binder, rolling the mixture into thin sheets of about 100 μm thick, and cutting into circular electrodes of 0.64 cm² area. The coin cells were assembled with the thus fabricated cathodes, lithium foil anode, 1 M LiPF₆ in ethylene carbonate/diethyl carbonate (EC/DEC) electrolyte, and Celgard polypropylene separator. EIS measurements were conducted with a Solartron 1260A impedance analyzer in the frequency range of 100 kHz to 0.001 Hz with an ac voltage amplitude of 10 mV. Before the EIS measurements, all samples were charged to the same 50% state of charge (SOC). Li foil served as both counter and reference electrodes during the EIS measurements.

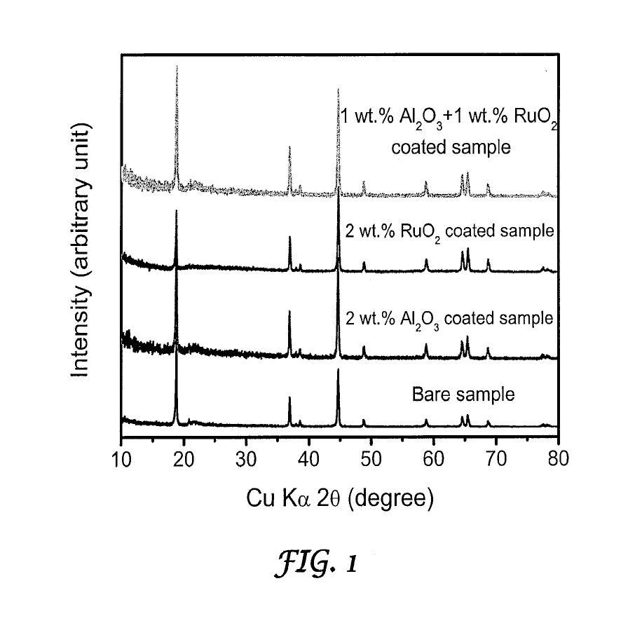

FIG. 1 is a plot of the XRD patterns of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples. The bare sample has the typical O3 layered structure with the weak superstructure reflections observed around 2θ=20−25° corresponding to the ordering of the transition metal ions and Li ions in the transition metal layer of the layered lattice.¹ The surface modifications change neither the main reflections nor the superstructure reflections, indicating that surface modified samples maintain the O3 layered structure with cation ordering. No extra reflections corresponding to Al₂O₃ and RuO₂ are observed with the surface modified samples, which might be due to the small quantity of surface modifying materials.

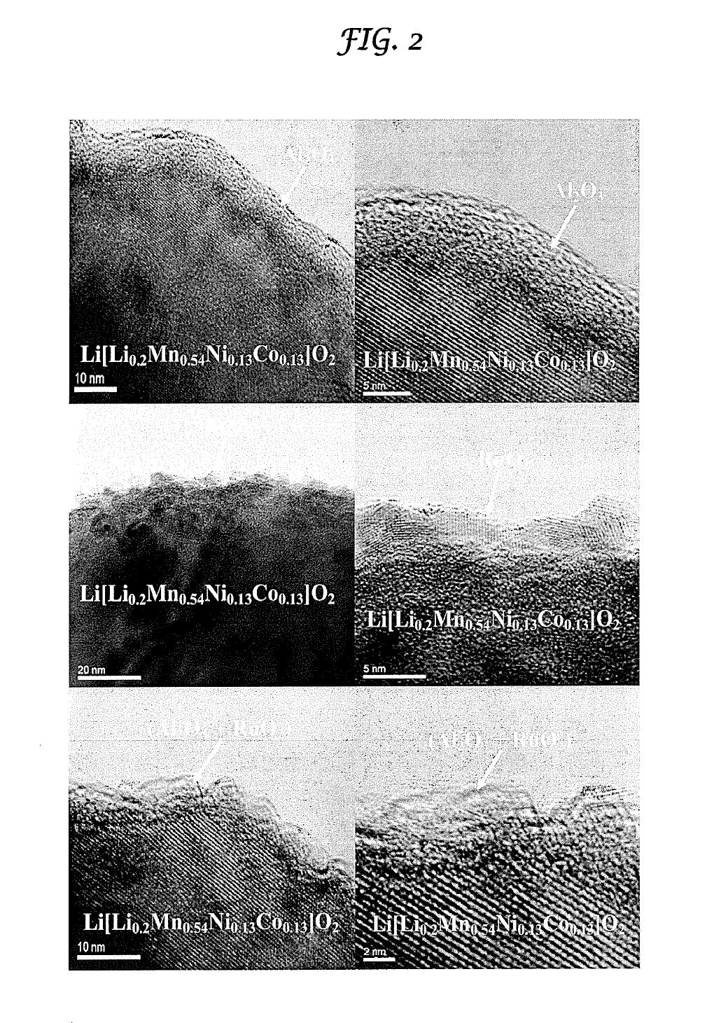

FIG. 2 is a series of high resolution TEM images of 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples at different magnifications. The images illustrate a coating of Al₂O₃, RuO₂, Al₂O₃+RuO₂ on the surface of the highly crystalline (as indicated by the fringe patterns) Li[Li_{0.2}Mn_{0.54}Ni_{0.13}Co_{0.13}]O₂. Interestingly, the microstructures of these surface modification layers differ depending on the coating material. While the Al₂O₃ modification layer forms a continuous, porous, amorphous coating (as indicated by the absence of fringe patterns) on the surface of Li[Li_{0.2}Mn_{0.54}Ni_{0.13}Co_{0.13}]O₂ with a thickness of about 4 nm, the RuO₂ modification layer forms a discrete, crystalline coating (as indicated by the fringe pattern) with a thickness of about 2-3 nm. The Al₂O₃+RuO₂ modification layer, on the other hand, forms a continuous, semi-crystalline coating (as indicated by the weak fringe pattern) with a thickness of about 3 nm. The weak fringe pattern of the Al₂O₃+RuO₂ modification layer also indicates Al₂O₃ and RuO₂ are uniformly mixed in the modification layer.

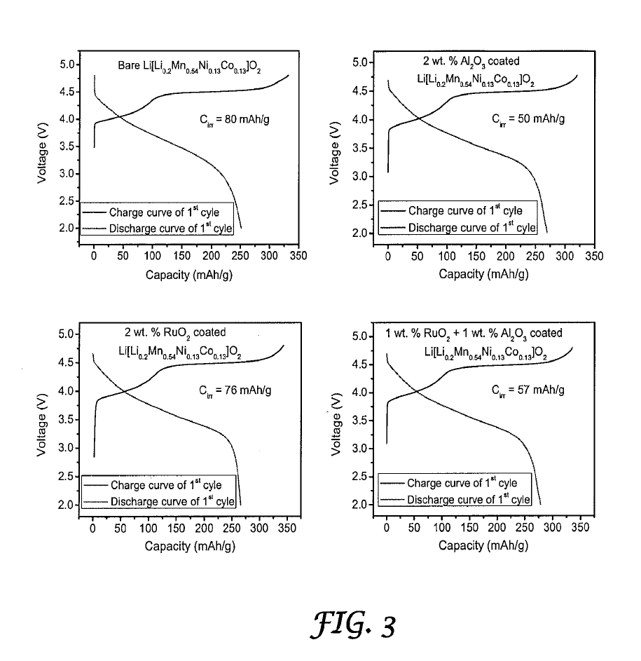

FIG. 3 is a series of plots showing the first charge-discharge curves of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples at C/20 rate. All the samples exhibit a plateau around 4.5 V in the first charge profile, which has been mainly attributed to a loss of oxygen from the layered lattice.⁸ This plateau region is absent in the subsequent charge profiles, indicating that the oxygen loss during first charge is an irreversible process.²⁴ It is also seen in FIG. 3 that the first charge capacity is larger than the discharge capacity. This irreversible capacity (Cᵢᵣᵣ) loss is due to the elimination of part of the oxide ion vacancies and a corresponding number of lithium ion sites as well as side reactions with the electrolyte at the high operating voltage.^{14,24}

The first charge and discharge capacity values as well as the Cᵢᵣᵣ values collected at C/20 rate are given in Table 1 for the bare and surface modified samples.

TABLE 1
Electrochemical data of the layered
Li[Li_{0.2}Mn_{0.54}Ni_{0.13}Co_{0.13}]O₂ before and
after surface modifications.

| | | | Cᵢᵣᵣ | Capacity |
|---|---|---|---|---|
| | First cycle | | loss | retention |
| | capacity (mAh/g) | | in first | in 30 |
| | Charge | Discharge | cycle | cycles |
| Samples | capacity | capacity | (mAh/g) | (%) |
| Bare sample | 332 | 252 | 80 | 92.8 |
| Al₂O₃ coated sample | 320 | 270 | 50 | 94.6 |
| RuO₂ coated sample | 342 | 266 | 76 | 91.7 |
| Al₂O₃ + RuO₂ coated | 335 | 278 | 57 | 94.3 |
| sample | | | | |

Compared to the bare sample, the Al₂O₃ coated sample shows a decreased first charge capacity and an increased first discharge capacity, which can be attributed to suppression of both the oxide ion vacancy elimination and the side reactions of the electrolyte. In contrast, the RuO₂ coated sample shows an increased first charge capacity compared to the bare sample, which might be due to the more serious side reactions of the electrolyte caused by the overlap of the Ru⁴⁺ 4d band with the O²⁻ 2p band.²⁵ Interestingly, the Al₂O₃+RuO₂ coated sample shows a smaller first charge capacity and a much reduced Cᵢᵣᵣ value compared to the RuO₂ coated sample, suggesting that the incorporation of Al₂O₃ into the surface modification layer reduces effectively the side reaction of the electrolyte with the RuO₂ coating. Interestingly, the high discharge capacity of the Al₂O₃+RuO₂ coated sample could be attributed to the positive effects of both the Al₂O₃ and RuO₂ surface modifications.

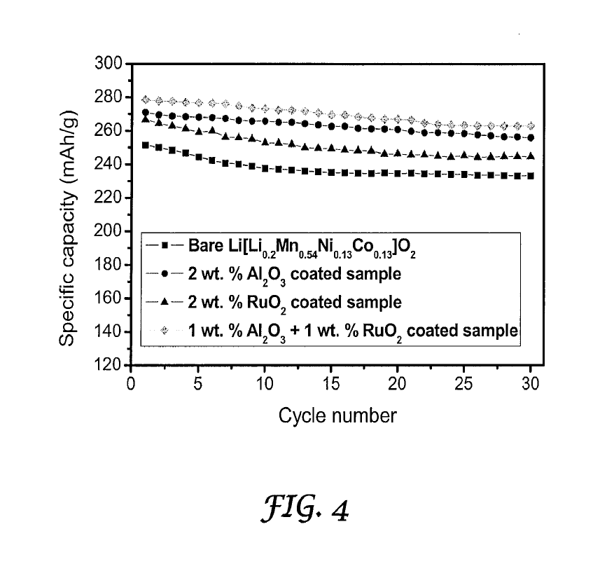

FIG. 4 is a plot of the cycling performance of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples. FIG. 4 shows the cycling performances of the bare and the surface modified Li[Li_{0.2}Mn_{0.54}Ni_{0.13}Co_{0.13}]O₂ at C/20 rate, and the capacity retention values are given in Table 1. The bare sample shows a capacity retention of 92.8% in 30 cycles; the capacity fade could be due to the further elimination of oxide ion vacancies as the cathode is cycled and the aggravating side reactions of the electrolyte at the high cutoff charge voltages. Comparatively, the Al₂O₃ coated sample exhibits the best capacity retention (94.6%) and the RuO₂ coated sample shows the worst capacity retention (91.7%) in 30 cycles. The capacity fade data again indicate that the more serious side reactions of RuO₂ may lead to faster capacity fade during cycling. The best cyclability of the Al₂O₃ coated sample is due to the suppression of the elimination of oxide ion vacancies and side reactions of the electrolyte. The intermediate cycling behavior of the Al₂O₃+RuO₂ coated sample illustrates the protective function of Al₂O₃ in the Al₂O₃+RuO₂ layer.

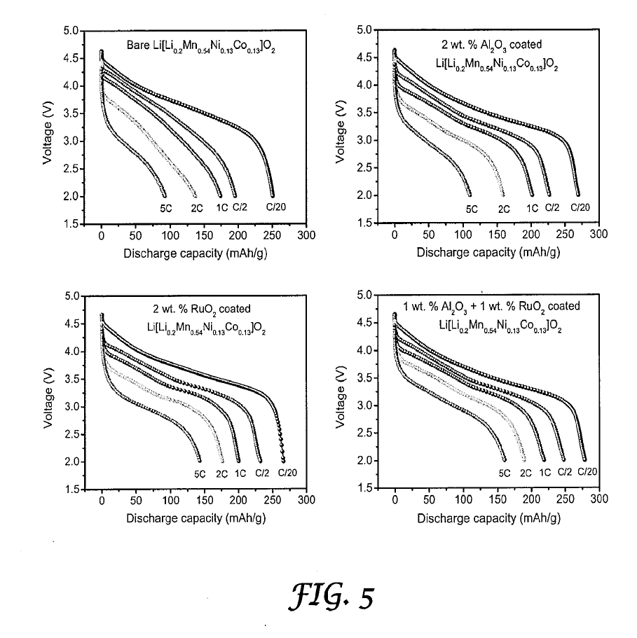

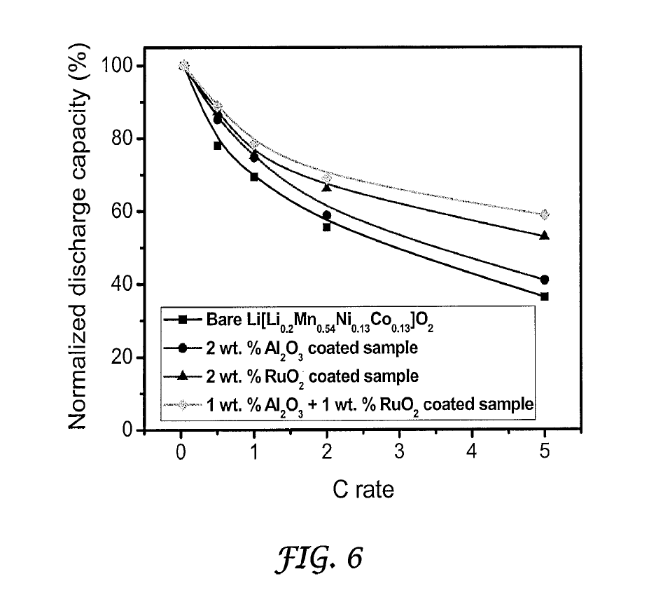

FIG. 5 is a series of plots showing the discharge profiles of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples at various C rates. FIG. 5 compares the discharge profiles recorded at different C rates after charging the bare and surface modified samples at C/20 rate. At a given C rate, all the surface modified samples show higher discharge capacity compared to the bare sample. For example, the bare sample delivers a discharge capacity of 92 mAh/g at 5 C rate, while the Al₂O₃, RuO₂, and Al₂O₃+RuO₂ coated samples exhibit a discharge capacity of, respectively, 143 mAh/g, 110 mAh/g, and 161 mAh/g. To obtain a clear comparison of the rate capabilities, the capacity values at various C rates is normalized to that at C/20 and the results are shown in FIG. 6. FIG. 6 is a plot of the comparison of the rate capabilities of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples. As seen, the rate capability increases in the order bare sample<Al₂O₃ coated sample<RuO₂ coated sample<Al₂O₃+RuO₂ coated sample. Thus, while the Al₂O₃ coating helps to reduce the Cᵢᵣᵣ value and increase the discharge capacity, the RuO₂ coating is effective in improving the rate capability. The combination of both Al₂O₃ and RuO₂ in the coating layer helps to enhance the surface lithium ion and electronic conductivites, resulting in the highest rate capability for the Al₂O₃+RuO₂ coated sample.

The differences in rate capability generally arises from different polarization behaviors.²⁶ EIS is a versatile technique for analyzing the differences in the polarization behaviors and thus for understanding the differences in rate capability.¹³ Accordingly, EIS measurements were carried out on both the bare and the surface modified samples after 3 charge-discharge cycles. Before the EIS measurements, all the samples were charged to 50% state of charge (SOC) at C/20 rate to reach an identical status. According to our previous EIS studies on this type of layered oxide cathodes,^{14,24} generally two semicircles and one slope are present in the EIS spectra: the first semicircle (at high frequency region) is ascribed to lithium ion diffusion through the surface layer, the second semicircle (at medium-to-low frequency region) is assigned to charge transfer reaction, and the slope at the low frequency region is attributed to lithium ion diffusion in the bulk material.

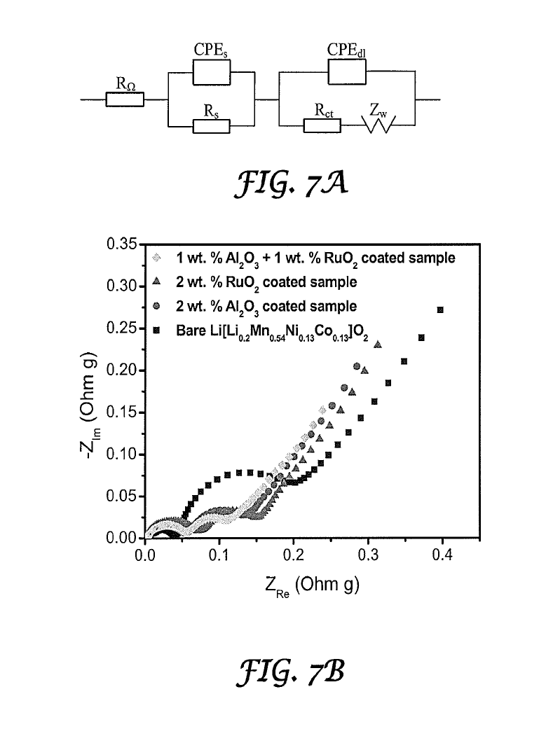

FIG. 7A is a schematic of the equivalent circuit and FIG. 7B is a plot of the EIS spectra of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples. Based on the above understanding, the equivalent circuit to analyze the EIS data is given in FIG. 7(a). In this equivalent circuit, R_{Ω} refers the uncompensated ohmic resistance between the working electrode and the reference electrode, Rₛ, represents the resistance for lithium ion diffusion in the surface layer (including SEI layer and surface modification layer), CPEₛ is the constant phase-angle element depicting the non-ideal capacitance of the surface layer, R_{ct} refers to charge transfer resistance, Z_{w} represents the Warburg impedance describing the lithium ion diffusion in the bulk material, and CPE_{dl} is the constant phase-angle element depicting the non-ideal capacitance of the double layer. Among these parameters, R_{Ω}, R_{ct} and Z_{w} can be used to quantify the polarization behaviors, i.e, ohmic polarization, activation polarization (also termed as charge transfer polarization), and diffusion polarization.

EIS spectra of the bare and the surface modified Li[Li_{0.2}Mn_{0.54}Ni_{0.13}Co_{0.13}]O₂ are shown in FIG. 7(b). Clearly, the value of R_{Ω}, which is given by the intersection of the first semicircle with the horizontal axis at very high frequency, is negligible for all samples; it indicates that the ohmic polarization of the investigated samples is negligible. Also, the particle size and crystallographic structure do not change on going from the bare sample to the coated samples, suggesting that Z_{w} and the diffusion polarization could be similar for the bare and the surface modified samples. Therefore, the differences in rate capabilities between the bare and the surface modified samples should arise mainly from the differences in the charge transfer polarization given by the different R_{ct} values.

The values of Rₛ, and R_{ct} of the bare and the surface modified Li[Li_{0.2}Mn_{0.54}Ni_{0.13}Co_{0.13}]O₂ are listed in Table 2.

TABLE 2
Surface resistance (Rₛ) and charge transfer resistance (R_{ct}) of
the layered Li[Li_{0.2}Mn_{0.54}Ni_{0.13}Co_{0.13}]O₂
before and after surface modifications.

| | Bare | Al₂O₃ | RuO₂ | Al₂O₃ + RuO₂ |
|---|---|---|---|---|
| | sample | coated sample | coated sample | coated sample |
| Rₛ | 0.040 | 0.052 | 0.069 | 0.056 |
| (ohm g) | | | | |
| R_{ct} | 0.172 | 0.099 | 0.086 | 0.068 |
| (ohm g) | | | | |

All surface modified samples show larger Rₛ compared to the bare sample, which could be due to the additional resistance induced by lithium ion diffusion in the surface modification layer. In contrast, all the surface modified samples show much smaller R_{ct} compared to the bare sample, and the R_{ct} value decrease in the order bare sample>Al₂O₃ coated sample>RuO₂ coated sample>Al₂O₃+RuO₂ coated sample, which is exactly the reverse order of the rate capability discussed earlier. This result confirms that the better rate capability of the coated samples including the highest rate capability of the Al₂O₃+RuO₂ coated sample is due to the lower charge transfer polarization.

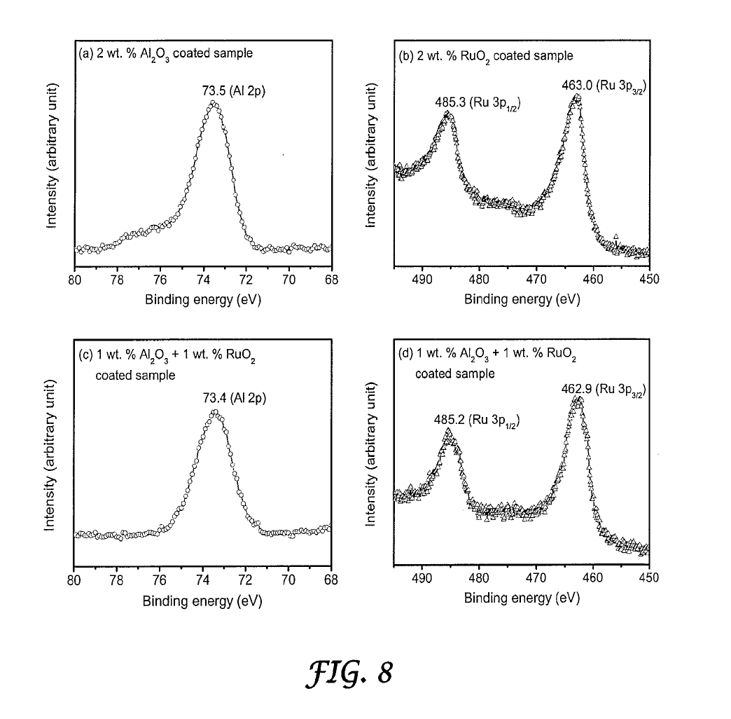

Surface property is vital in controlling the electrochemical performances of battery electrode materials. The surface properties of the surface modified samples are expected to differ from each other as well as from the bare sample due to the differences in the chemical and surface characteristics of the coating materials. Accordingly, XPS was employed to investigate the chemical states of the different surface modification layers, and the XPS spectra of the various surface modification layers are shown in FIG. 8.

FIG. 8 is a series of plots showing the XPS spectra of 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂: (a) Al 2p spectrum of 2 wt. % Al₂O₃ coated sample, (b) Ru 3p spectrum of 2 wt. % RuO₂ coated sample, and (c) Al 2p spectrum and (d) Ru 3p spectrum of 1 wt. % Al₂O₃+1 wt. % RuO₂ coated sample. FIG. 8(a) shows the Al 2p spectrum of the Al₂O₃ modified sample. The Al 2p peak appears at 73.5 eV, which is lower than that observed in Al₂O₃ (74.2 eV),²⁶ but is close to that reported for LiAlO₂ (73.4 eV)²⁷ which is known to have a good lithium ion conductivity.²⁸ The data suggest that Al₂O₃ might have reacted with lithium ions in the cathode during the annealing process at 450° C. of the surface modified samples and formed LiAl₁₋ₓMₓO₂ (M=Mn, Co, and Ni) on the surface.

FIG. 8(b) shows the Ru 3p spectrum of the RuO₂ modified sample. The Ru 3p_{1/2} and 3p_{3/2} peaks occur, respectively, at 485.3 and 463.0 eV, which agree well with the Ru 3p binding energy values reported for thin-film RuO₂²⁹ and nanocrystalline RuO₂,³⁰ confirming that the chemical state of Ru in the surface modification layer is similar to that in RuO₂. RuO₂ has been studied as a cathode materials for over four decades.³¹⁻³³ The lithium insertion/extraction process in RuO₂ cathode is a topotactic two-phase reaction involving rutile RuO₂ [symbol] tetragonal intermediate [symbol] orthorhombic LiRuO₂.²⁹ In the potential range used in this study (i.e., 2.0-4.8 V), all three phases, which are both electronically and ionically conductive,^{32,33} can be formed.

This indicates that the RuO₂ modification layer can serve as both fast electron transfer and fast lithium ion diffusion channels.

FIGS. 8(c) and (d) show both the Al 2p and Ru 3p spectra of Al₂O₃+RuO₂ modified sample. The binding energy values of the Al 2p, Ru 3p_{1/2}, and 3p_{3/2} peaks appear at, respectively, 73.4, 485.2 and 462.9 eV, which match closely with those measured with the Al₂O₃ modified and RuO₂ modified samples, indicating that Al and Ru exist as LiAl₁₋ₓMₓO₂ (M=Mn, Co, and Ni) and RuO₂ in the Al₂O₃+RuO₂ modification layer. Since LiAl₁₋ₓMₓO₂ is also a good lithium ion conductor, the Al₂O₃+RuO₂ modification provides the protection of the cathode surface from direct reaction with the electrolyte (see TEM images in FIGS. 2 and EIS spectra in FIG. 7(b)) without compromising the surface conductivities. The protection function along with an enhancement in surface electronic and lithium ion conduction leads to better rate capability for the Al₂O₃+RuO₂ coated sample.

SEI thickness is an important factor in determining the electrochemical performances of the cathode materials.³⁴ While the SEI layer formed on the commercially used layered LiCoO₂ cathode is thin due to the mild operating voltage range (<4.3 V vs Li/Li⁺) that formed on the surface of the Li[Li_{0.2}Mn_{0.54}Ni_{0.13}Co_{0.13}]O₂ cathode could be quite thick because of the high cut-off voltage (4.8 V), which can cause serious electrolyte decomposition on the cathode surface. The thickness of the SEI layers on different samples could be semi-quantitatively compared by employing the XPS sputtering technique, if the composition and microstructure of the SEI layers do not differ significantly.¹³ LiF has been reported to be a major component of the SEI layers formed in LiPF₆ based eletrolytes.³⁵ Accordingly, we analyzed the depth profiles of LiF on the bare and the surface modified samples to compare the thickness of SEI layers.

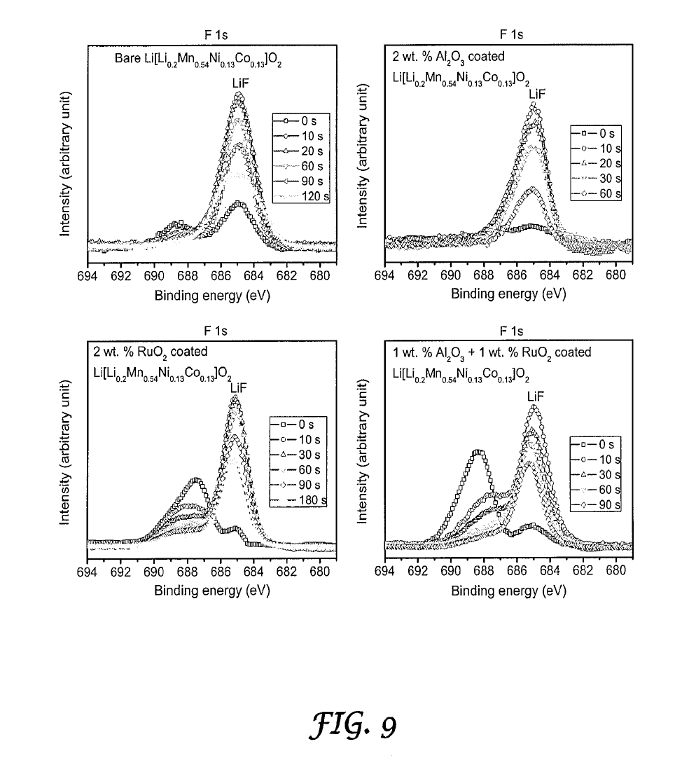

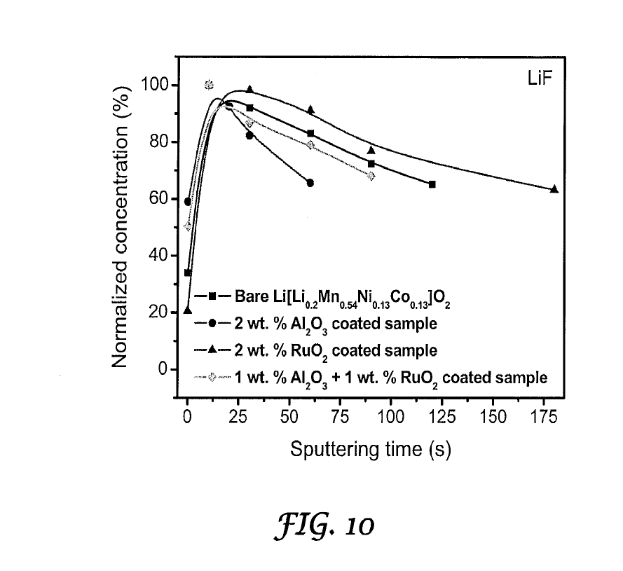

FIG. 9 is a series of plots showing the F 1s XPS spectra of the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples at different sputtering times after 30 charge-discharge cycles. FIG. 9 compares the F 1s photoemission peaks of the bare and surface modified samples at various sputtering times. The main peaks at about 685 eV are assigned to LiF, while the peaks above 687 eV are assigned to LiPF₆, LiₓPF_{y}, and LiₓPOF_{y} formed by a reaction of the LiPF₆ salt.³⁶ For each sample, the concentration of LiF at different depths (i.e. after different sputtering time) was normalized with respect to its maximum value, and the normalized concentration of LiF is plotted as a function of sputtering time in FIG. 10.

FIG. 10 is a plot of the variations of the normalized LiF concentration with sputtering time for the bare and 2 wt. % Al₂O₃, 2 wt. % RuO₂, and 1 wt. % Al₂O₃+1 wt. % RuO₂ coated Li[Li_{0.2}Mn_{0.54}Ni_{0.13}Co_{0.13}]O₂ samples. As seen, the concentration of LiF at a given depth or after a given sputtering time varies significantly on going from one sample to another.

In other words, it takes different sputtering time to reach a specific concentration of LiF. For example, to see a LiF concentration of 68% of the maximum value, it takes 106, 55, 146, and 90 s, respectively, for the bare, Al₂O₃, RuO₂, and Al₂O₃+RuO₂ coated Li[Li_{0.2}Mn_{0.54}Ni_{0.13}Co_{0.13}]O₂ samples. The results indicate that the thickness of the SEI layer decreases in the order RuO₂ coated sample>bare sample>Al₂O₃+RuO₂ coated sample>Al₂O₃ coated sample. This order confirms that RuO₂ causes more serious electrolyte decomposition reaction as discussed earlier based on the electrochemical data, and indicates that addition of Al₂O₃ into the RuO₂ modification layer effectively suppresses the side reaction. In fact, the thinner SEI layer on the Al₂O₃+RuO₂ coated sample is another reason leading to faster charge transfer kinetics (lower R_{ct}) and better rate capability compared to the RuO₂ coated sample.

The high capacity layered oxide Li[Li_{0.2}Mn_{0.54}Ni_{0.13}Co_{0.13}]O₂ has been surface modified with 2 wt. % Al₂O₃, 2 wt. % RuO₂, and 1 wt. % Al₂O₃+1 wt. % RuO₂. The surface modified samples exhibit improved electrochemical performances compared to the bare sample, with the Al₂O₃+RuO₂ modified sample exhibiting the best performance. While the Al₂O₃ coating serves as a good protection layer suppressing both the oxide ion vacancy elimination and the side reactions of the electrolyte, the RuO₂ coating serves as a fast electron transfer and a fast lithium ion diffusion channels on the surface of the cathode. Therefore, the combined Al₂O₃+RuO₂ coating taking advantage of the functions of both Al₂O₃ and RuO₂ leads to the highest discharge capacity and rate capability. The Al₂O₃+RuO₂ coated sample retains about 60% of the capacity on going from C/20 to 5C rate while the bare sample retains only about 40%. The study demonstrates that functional surface modification with appropriate materials is a viable approach to overcome the rate capability limitations of the high capacity lithium-excess layered oxide cathodes.

Electrode films consisting of the Li[Li_{0.2}Mn_{0.54}Ni_{0.13}Co_{0.13}]O₂ cathode material was prepared by a slurry coating technique. Li[Li_{0.2}Mn_{0.54}Ni_{0.13}Co_{0.13}]O₂ powder, conductive carbon, and PVDF binder were mixed in a ratio of 8:1:1 in N-methylpyrrolidinone (NMP) solvent and stirred for 24 hour to form a uniform slurry. The slurry was then coated on an aluminum foil to make the electrode film, followed by drying overnight at 100° C. in a vacuum oven. The thickness of the electrode film was controlled at about 50 μm.

Surface modification of the Li[Li_{0.2}Mn_{0.54}Ni_{0.13}Co_{0.13}]O₂ electrode film with Al was carried out by a thermal evaporation process with a JEOL thermal evaporator. High purity aluminum wire (99.9995%) hung on a tungsten basket was transformed into gaseous state by passing a current of 15 A under a vacuum of about 10⁻⁷ Torr and deposited directly onto the fabricated electrode film. The amount of Al coating on the surface of the electrode film was semi-quantitatively controlled by controlling the deposition time.

X-ray diffraction (XRD) data were collected with a Phillips X-ray diffractometer with Cu Kα radiation between 10° and 80° at a scan rate of 0.01°/s. SEM data were collected with a Hitachi S-5500 equipment to assess the microstructures of the samples before and after surface modification. Surface conductivity of the electrode films was measured with a four-probe conductivity measurement system (a Lucas Signatone four-point probe head and stand, combined with a Keithley 2400 source meter).

Electrochemical performances were evaluated with CR2032 coin cells between 4.8 and 2.0 V. The coin cells were assembled with the thus fabricated film cathodes, lithium foil anode, 1 M LiPF₆ in ethylene carbonate/diethyl carbonate (EC/DEC) electrolyte, and Celgard polypropylene separator. EIS measurements were conducted with a Solartron 1260A impedance analyzer in the frequency range of 100 kHz to 0.001 Hz with an AC voltage amplitude of 10 mV. Before the EIS measurements, all the samples were charged to the same 50% state of charge (SOC). Li foil served as both counter and reference electrodes during the EIS measurements.

Since the Al modification layer could protect the cathode surface from side reactions with the electrolyte and improve the electrical contact between particles, the surface microstructure such as the coverage and thickness of the Al modification layer on the electrode film could play an important role on the electrochemical performances of the Al-modified samples.

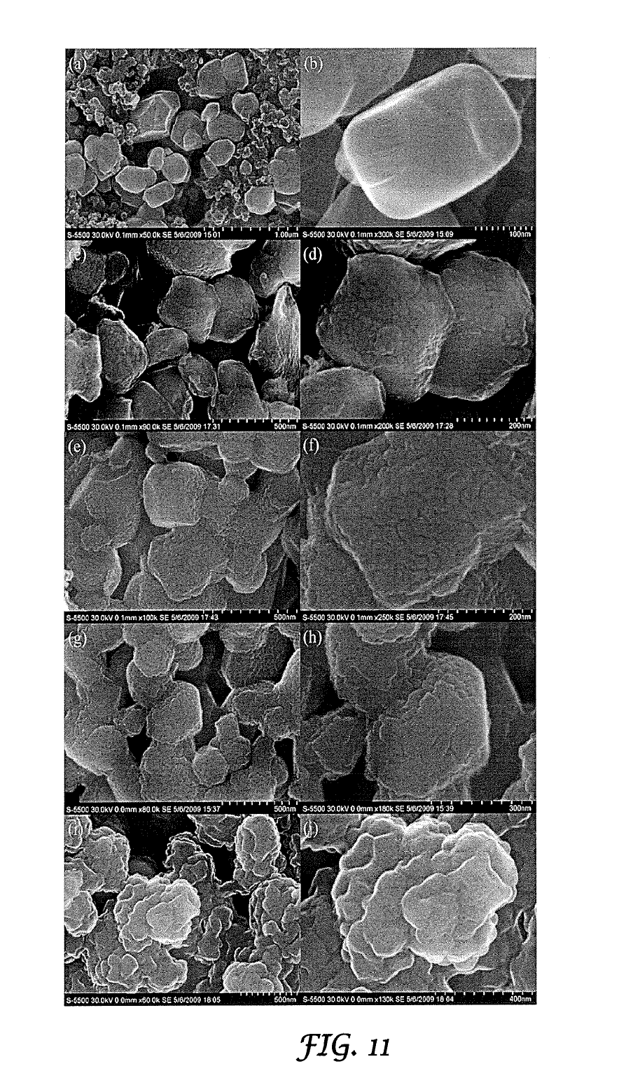

FIGS. 11A-11J are SEM images of (a) & (b) the bare, (c) & (d) 10 s Al-coated, (e) & (f) 20 s Al-coated, (g) & (h) 30 s Al-coated, and (i) & (j) 60 s Al-coated Li[Li_{0.2}Mn_{0.54}Ni_{0.13}Co_{0.13}]O₂. FIG. 11 compares the SEM images revealing the surface structure of the Li[Li_{0.2}Mn_{0.54}Ni_{0.13}Co_{0.13}]O₂ electrode films before and after surface modification with Al. Obviously, with increasing Al deposition time, both the coverage of Al on the particle surface and the thickness of Al modification film increase, and a better connection between particles is formed by “Al bridges.” It is also observed that for the 60 s Al-coated sample, the morphology of the particles is totally different from that of the unmodified pristine sample due to the thick and irregular Al layer accumulated on the surface of the particles. However, the Al modification layer is not permeable for lithium ions, so too thick an Al layer would degrade the electrochemical performance. In other words, there might be an optimum thickness for the Al modification layer to realize good electrochemical performance.

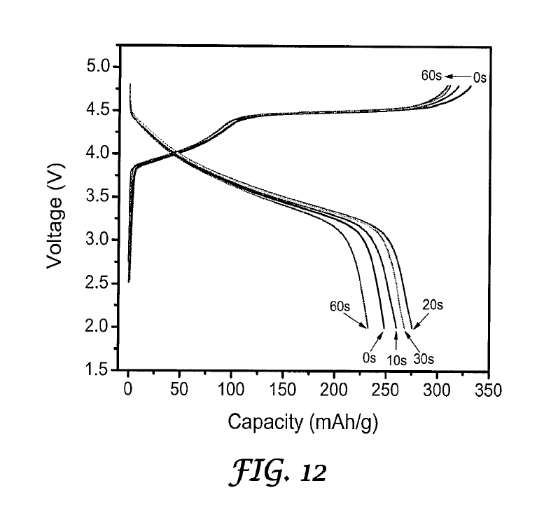

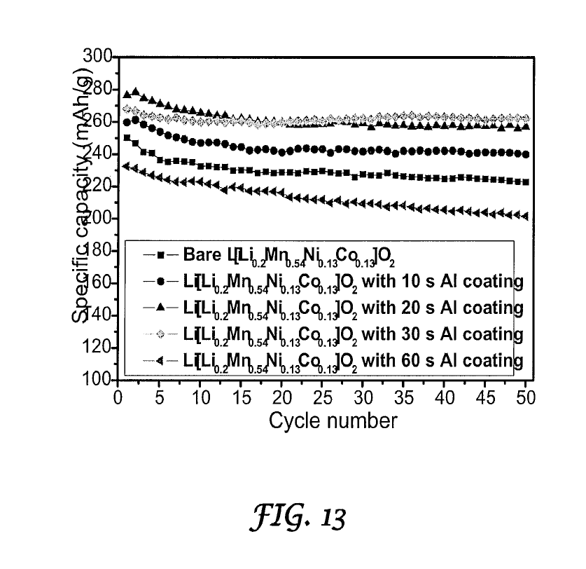

FIG. 12 is a plot of the first charge-discharge curves of the bare and 10, 20, 30, and 60 s Al-coated Li[Li_{0.2}Mn_{0.54}Ni_{0.13}Co_{0.13}]O₂ cathodes. FIG. 13 shows the first charge-discharge profiles of the bare and the Al-coated Li[Li_{0.2}Mn_{0.54}Ni_{0.13}Co_{0.13}]O₂ cathodes at a current density of 12.5 mA/g (C/20 rate). All the samples exhibit a plateau around 4.5 V in the first charge profile, which has been attributed to a loss of oxygen from the layered lattice. All the samples show a difference between the first charge and discharge capacities, resulting in an irreversible capacity loss Cᵢᵣᵣ in the first cycle. The irreversible capacity loss is due to the elimination of part of the oxygen vacancies and a corresponding number of lithium sites at the end of first charge, as discussed before with the Al₂O₃ modified samples, and possible side reactions of the cathode surface with the electrolyte during first charge.

Table 3 summarizes the first charge and discharge capacity values along with the Cᵢᵣᵣ values for all the samples. The first charge capacity decreases with increasing Al-coating time from 0 to 60 s, while the discharge capacity increases with Al-coating time, reaches a maximum at an Al-coating time of 20 s and then decreases with Al-coating time. As a result, the Cᵢᵣᵣ value decreases with Al-coating time, reaches a minimum at 20 s, and then increases. The increase in discharge capacity and decrease in Cᵢᵣᵣ value with Al-coating is due to the retention of more number of oxygen vacancies and lithium sites in the layered lattice at the end of first charge compared to that in the bare sample, similar to that found by us before with the Al₂O₃— and AlPO₄ modified samples.

In order to have a quantitative assessment, we calculated the percentage of the oxygen vacancies retained in the layered lattice after the first charge based on the observed first charge and discharge capacity values by a procedure described earlier,¹⁴ and the results are given in Table 3.

TABLE 3
Electrochemical data of layered Li[Li_{0.2}Mn_{0.54}Ni_{0.13}Co_{0.13}]O₂
before and after Al coating

| | | | Irreversible | |
|---|---|---|---|---|
| | | | capacity | |
| | First cycle capacity | | loss | Oxygen |
| | (mAh/g) | | in the | vacancy |
| | Charge | Discharge | first cycle | retention |
| Sample | capacity | capacity | (mAh/g) | (%) |
| Bare sample | 330 | 248 | 82 | 33 |
| 10 s Al-coated sample | 319 | 260 | 59 | 47 |
| 20 s Al-coated sample | 312 | 276 | 36 | 67 |
| 30 s Al-coated sample | 310 | 268 | 42 | 63 |
| 60 s Al-coated sample | 309 | 232 | 77 | 25 |

We illustrate the calculation below by taking the 20 s Al-coated cathode as an example. If the first charge capacity of 312 mAh/g is exclusively due to lithium ion extraction (assuming no side reaction with the electrolyte contributes to the first charge capacity), it will correspond to the extraction of 0.99 lithium ions from the lattice. Out of this, the extraction of 0.34 lithium ions is due to the oxidation of Ni²⁺ and Co³⁺, respectively, to Ni⁴⁺ and Co^{3.6+}.⁷ For simplicity, writing the Li[Li_{0.2}Mn_{0.54}Ni_{0.13}Co_{0.13}]O₂ formula as Li[Li_{0.2}M_{0.8}]O₂, where M_{0.8} refers to Mn_{0.54}Ni_{0.13}Co_{0.13}, this lithium extraction process can be written as

Li[Li_{0.2}M_{0.8}]O₂→Li_{0.66}[Li_{0.2}M_{0.8}]O₂+0.34Li⁺+0.34e⁻ (1)

The extraction of the remaining 0.65 lithium ions (0.99-0.34) involves an oxidation of the O²⁻ ions and a loss of oxygen from the lattice as

Li_{0.66}[Li_{0.2}M_{0.8}]O₂→Li_{0.01}[Li_{0.2}M_{0.8}]O_{1.675□0.325}+0.65Li⁺+0.65e⁻+0.1625O₂ (2)

A migration of lithium ions from the transition metal layer to the lithium layer and an elimination of some oxygen vacancies and a corresponding number of lithium sites to maintain the ratio between the cations in the transition metal layer and oxygen sites as 1:2, we can arrive at a configuration,

Li_{0.01}[Li_{0.2}M_{0.8}]O_{1.675□0.325}→Li_{0.063}[Li_{0.147□0.053}M_{0.8}]O_{1.675□0.325}→Li_{0.063}[Li_{0.147}M_{0.8}]O_{1.675□0.219} (3)

This results in a retention of 67% of the oxygen vacancies in the lattice at the end of first charge compared to a retention of 33% in the unmodified bare sample.

Based on the experimentally observed first discharge capacity of 276 mAh/g, which corresponds to an insertion of 0.844 lithium ions, and a 1:2 ratio between the available sites in the lithium layer and the oxygen sites, we can envision the first discharge reaction as

Li_{0.063}[Li_{0.147}M_{0.8}]O_{1.675□0.219}+0.884Li⁺+0.884 e⁻→Li_{0.947}[Li_{0.147}M_{0.8}]O_{1.675□0.219} (4)

Based on a similar calculation, we could arrive at the % oxygen vacancies retained in the layered lattice at the end of first charge, and the results are given in the last column of Table 3. It is clear that the Al-coating for 10-30 s leads to a retention of more number of oxygen vacancies and lithium sites in the lattice at the end of first charge compared to that in the bare sample, resulting in a reduced irreversible capacity loss. However, with a higher Al-coating time of 60 s, too thick an Al-coating layer could hinder the lithium extraction/insertion process and leads to a retention of less number of oxygen vacancies in the lattice.

FIG. 13 is a plot of the cycling performance of the bare and 10, 20, 30, and 60 s Al-coated Li[Li_{0.2}Mn_{0.54}Ni_{0.13}Co_{0.13}]O₂ cathodes. FIG. 13 compares the cycling performances of the bare and the Al coated Li[Li_{0.2}Mn_{0.54}Ni_{0.13}Co_{0.13}]O₂ cathodes. The capacity fade of this type of layered cathode materials could be due to both the aggravating side reactions with the electrolyte at the high operating voltage of up to 4.8 V and the possible elimination of some of the oxygen vacancies and lithium sites as the sample is cycled. As the Al-coating time increases from 0 to 30 s, the capacity retention in 50 cycles increases from 89% to 98%. However, the capacity retention decreases to 87% on increasing the Al-coating time to 60 s. The increase in capacity retention at shorter Al-coating times could be ascribed to the coverage of the electrode film surface by the Al layer and the suppression of the side reactions with the electrolyte and a slowing down of the rate of the oxygen vacancy elimination. The faster capacity fade of the 60 s Al-coated sample could be due to the impeding of the kinetics of lithium ion extraction/insertion process by too thick an Al layer. Since the 60 s Al-coated cathode shows lower capacity and faster capacity fade than the bare sample, our further experiments focused on the samples with an Al-coating time of up to 30 s.

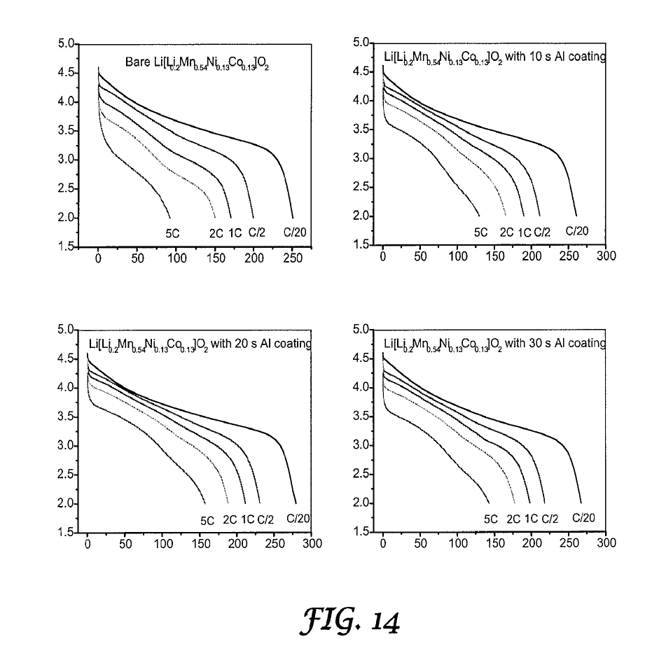

FIG. 14 is a series of plots showing the discharge profiles of the bare and 10, 20, and 30 s Al-coated Li[Li_{0.2}Mn_{0.54}Ni_{0.13}Co_{0.13}]O₂ cathodes at various C rates. The rate capabilities of the bare and Al-coated samples were assessed by charging them at a fixed current density of 12.5 mA/g (C/20 rate) and discharging at various C rates, and the discharge profiles recorded at various C rates are shown in FIG. 14. At a given C rate, the Al-coated samples exhibit higher discharge capacity than the bare sample. For example, while the bare cathode delivers a capacity of only 93 mAh/g at 5 C rate, the 10, 20, and 30 s Al-coated cathodes exhibit much higher discharge capacities of, respectively, 130, 157, and 143 mAh/g at the same 5C rate.

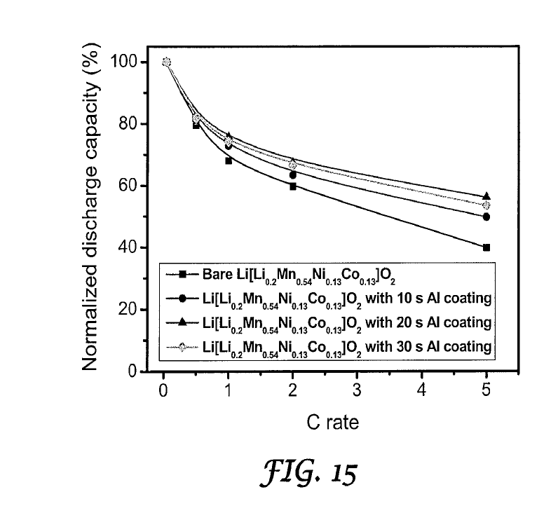

FIG. 15 is a plot of the normalized capacity vs. rate curves of the bare and 10, 20, and 30 s Al-coated Li[Li_{0.2}Mn_{0.54}Ni_{0.13}Co_{0.13}]O₂ cathodes. FIG. 15 plots the normalized discharge capacity values obtained at various C rates in reference to the value obtained at C/20 rate. As seen, the rate capability increases in the order bare cathode<10 s Al coated cathode<30 s Al coated cathode<20 s Al coated cathode. The results reveal that the Al-coating time and Al layer thickness play a critical role on the rate capability, and an Al-coating time of 20 s is optimum to provide the best rate capability.

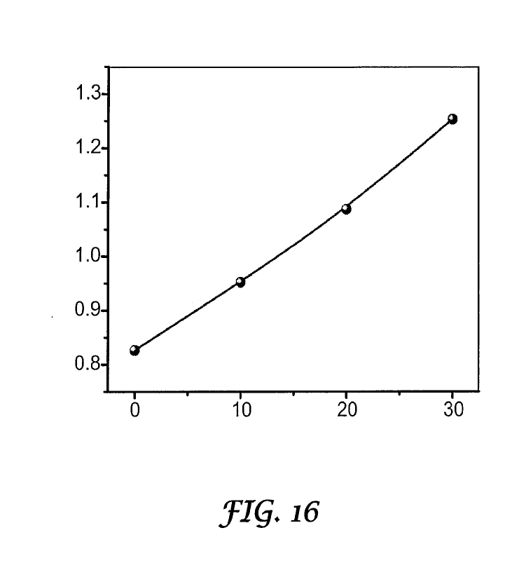

The differences in rate capability arise from the different polarization behavior. We can envision that the Al coating can enhance the surface conductivity of the particles and improve the electrical contact between particles. FIG. 16 is a plot of the variation of the surface conductivity of the Li[Li_{0.2}Mn_{0.54}Ni_{0.13}Co_{0.13}]O₂ electrodes with Al-coating time. FIG. 16 shows the relationship between the surface conductivity of the cathode films and Al-coating time. Clearly, the surface conductivity increases with increasing Al-coating time. Since the increased surface conductivity could decrease both the uncompensated ohmic resistance and the charge transfer resistance due to improved particle contact and faster electron transfer on the particle surface, the Al-coated cathode with longer coating time can be expected to have lower ohmic polarization and charge transfer polarization, leading to higher rate capability. However, the 20 s Al-coated cathode shows higher rate capability than the 30 or 60 s Al-coated cathodes, indicating that surface conductivity is not the only factor contributing to the differences in rate capability.

To gain a better understanding of factors leading to the differences in rate capability, EIS measurements were carried out on both the bare and the Al-coated cathodes after 3 charge-discharge cycles. Before the EIS measurements, all the samples were charged to 50% state of charge (SOC) to reach an identical status. According to our previous EIS study on this type of layered cathodes,^{14,24} there always appear two semicircles and one slope in the EIS spectra: the first semicircle (at high frequency region) is ascribed to lithium ion diffusion through the surface layer, the second semicircle (at medium-to-low frequency region) is assigned to the charge transfer reaction, and the slope at the low frequency region is attributed to lithium ion diffusion in the bulk material.

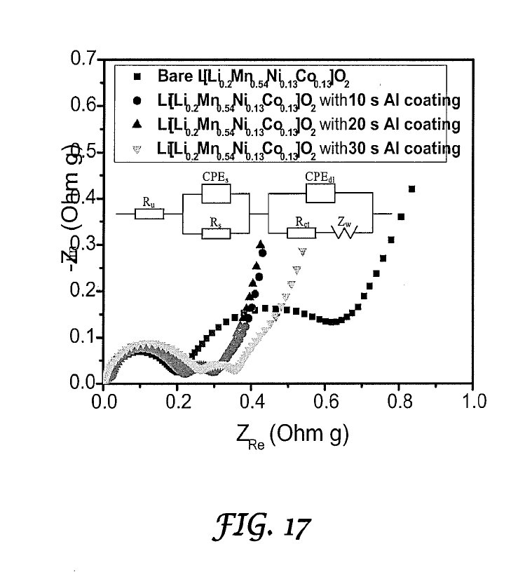

EIS spectra of the bare and the Al-coated cathodes, and the corresponding equivalent circuit are given in FIG. 17. In the equivalent circuit, Rᵤ refers to the uncompensated ohmic resistance between the working electrode and the reference electrode, Rₛ represents the resistance for lithium ion diffusion in the surface layer (including SEI layer and surface modification layer), CPEₛ refers to the constant phase-angle element depicting the non-ideal capacitance of the surface layer, R_{ct} refers to the charge transfer resistance, Z_{w} represents the Warburg impedance describing the lithium ion diffusion in the bulk material, and CPE_{dl} is the constant phase-angle element depicting the non-ideal capacitance of the double layer. Among these parameters, Rᵤ, R_{ct} and Z_{w} can be used to quantify the polarization behaviors, i.e, ohmic polarization, charge transfer polarization, and diffusion polarization.³⁷

Since the particle size and crystallographic structure can be assumed identical for the bare and the Al-coated samples (coating time ≦30 s), it can be assumed that Z_{w} and the diffusion polarization are identical for the bare and the Al-coated samples.³⁸ The values of Rᵤ, Rₛ, and R_{ct} are given, respectively, by the intersection of the first semicircle with the horizontal axis at high frequency, the diameter of the first semicircle, and the diameter of the second semicircle. FIG. 17 illustrates that the values of Rᵤ are negligible for all the samples, indicating the ohmic polarizations of the investigated samples can be neglected. Meanwhile, R_{ct} decreases in the order bare sample>10 s Al coated cathode>30 s Al coated cathode>20 s Al coated cathode, which follows the exact increasing order of rate capability. The results imply that the differences in the rate capability are predominantly due to the differences in the charge transfer polarization. It should be noted that the decreasing order of R_{ct} is not exactly the same with the increasing order of surface conductivity. The reason is that the charge transfer kinetics is affected by both the electron migration rate and lithium ion diffusion rate in the surface layer. Since Al is a good electronic conductor but a poor lithium-ion conductor, increasing the Al coating time will increase the surface electron migration rate (surface conductivity) while decreasing the surface lithium-ion diffusion rate. The 20 s Al-coated cathode appears to have high surface electron migration rate without compromising too much the surface lithium-ion diffusion rate, resulting in the smallest R_{ct} and the best rate capability.

The high capacity layered Li[Li_{0.2}Mn_{0.54}Ni_{0.13}Co_{0.13}]O₂ cathode has been coated with various amounts of aluminum by a thermal evaporation method. Electrochemical data reveal that the Al coating increases the discharge capacity, decreases the irreversible capacity loss in the first cycle, improves the cyclability, and enhances the rate capability. The increase in capacity is due to the suppression of oxygen vacancy elimination at the end of first charge, the improvement in cyclability is due to the suppression of both oxygen vacancy elimination and the side reaction with the electrolyte in the subsequent cycles, and the enhancement in rate capability is due to the enhanced surface conductivity by the Al coating layer.

The electrode film obtained with the Li[Li_{0.2}Mn_{0.54}Ni_{0.13}Co_{0.13}]O₂ sample was also surface modified with carbon. Surface modification of the electrode film with carbon was realized by thermal evaporation of a high purity graphite rod inside a JEOL thermal evaporator. The coating process was conducted at a vacuum of about 10⁻⁷ Ton and a current of 45 A.

The pristine and carbon-coated Li[Li_{0.2}Mn_{0.54}Ni_{0.13}Co_{0.13}]O₂ electrodes were characterized by XRD, SEM, surface conductivity, electrochemical charge-discharge, and EIS measurements.

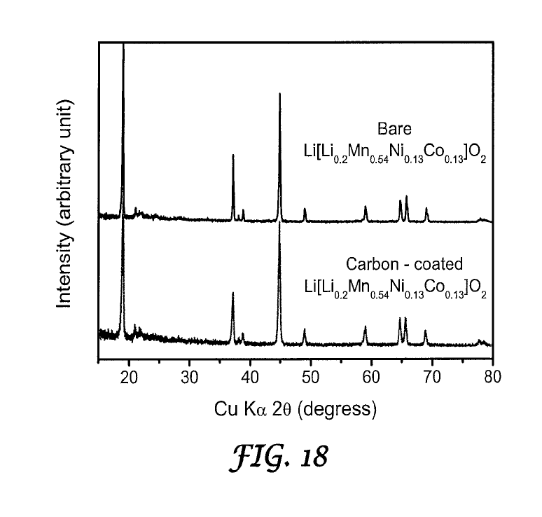

FIG. 18 is an image of XRD patterns of the bare and the carbon-coated Li[Li_{0.2}Mn_{0.54}Ni_{0.13}Co_{0.13}]O₂. FIG. 18 compares the XRD patterns of the bare and the carbon-coated Li[Li_{0.2}Mn_{0.54}Ni_{0.13}Co_{0.13}]O₂ electrodes. All the reflections correspond to the layered oxide¹ without any peaks for carbon due to the amorphous nature or low quantity of carbon.

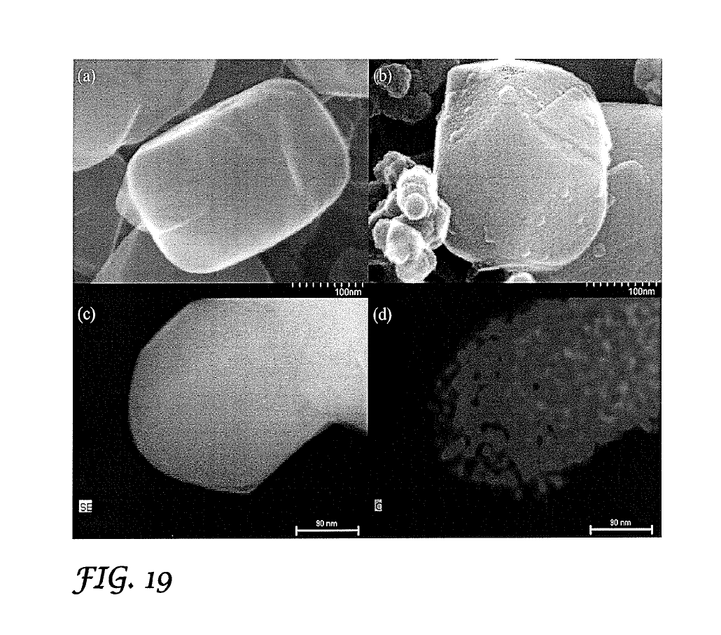

FIGS. 19A-19D are SEM images, where FIG. 19A is the SEM image of the bare Li[Li_{0.2}Mn_{0.54}Ni_{0.13}Co_{0.13}]O₂ particle, FIG. 19B is the SEM image of the carbon-coated Li[Li_{0.2}Mn_{0.54}Ni_{0.13}Co_{0.13}]O₂ particle, FIG. 19C is the scanning transmission electron microscope (STEM) image of the carbon coated Li[Li_{0.2}Mn_{0.54}Ni_{0.13}Co_{0.13}]O₂ particle, and FIG. 19D is the carbon map of the particle in the STM image. FIGS. 19A and 19B compare the SEM images of the Li[Li_{0.2}Mn_{0.54}Ni_{0.13}Co_{0.13}]O₂ particles on the electrode film before and after carbon coating. While the surface of the bare Li[Li_{0.2}Mn_{0.54}Ni_{0.13}Co_{0.13}]O₂ particle is smooth, it becomes coarse after carbon coating. FIGS. 19C and 19D gives the STEM image and the carbon mapping of the carbon-coated Li[Li_{0.2}Mn_{0.54}Ni_{0.13}Co_{0.13}]O₂ particle. The data reveal a uniform coating of carbon on the particle surface, indicating that thermal evaporation is an effective technique to realize good carbon coating. Surface electronic conductivity of the bare and the carbon-coated Li[Li_{0.2}Mn_{0.54}Ni_{0.13}Co_{0.13}]O₂ electrodes were found to be, respectively, 0.696 and 0.975 S cm⁻¹, indicating a 40% enhancement in surface electronic conductivity on coating with carbon.

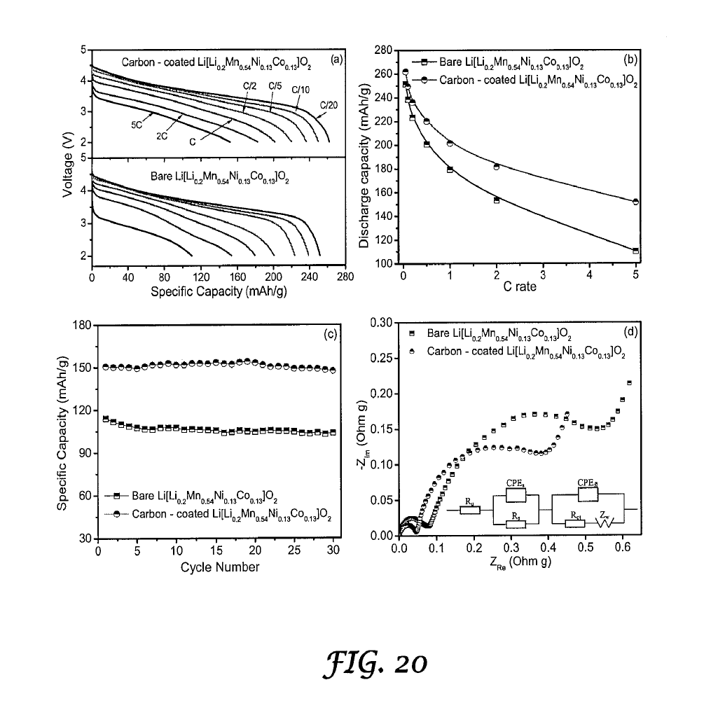

FIGS. 20A-20D are plots where FIG. 20A is a plot of the discharge profiles at various C rates, FIG. 20B is a plot of the variation of discharge capacity with C rate, FIG. 20C is a plot of the cycling performance at 2C charge-discharge rate, and FIG. 20D is the EIS plots of the bare and the carbon-coated Li[Li_{0.2}Mn_{0.54}Ni_{0.13}Co_{0.13}]O₂. In the equivalent circuit in FIG. 20D, Rᵤ, Rₛ, CPEₛ, R_{ct}, Z_{w}, and CPE_{dl} refer, respectively, to the uncompensated ohmic resistance between the working electrode and the reference electrode, resistance for lithium-ion diffusion in the surface layer (including SEI layer and surface modification layer), constant phase-angle element depicting the non-ideal capacitance of the surface layer, charge transfer resistance, Warburg impedance describing the lithium-ion diffusion in the bulk material, and constant phase-angle element depicting the non-ideal capacitance of the double layer. FIGS. 20A and 20B compare the discharge profiles and discharge capacities at various C rates of the electrodes before and after coating with carbon. The data were collected by charging at a current density of 12.5 mA/g (C/20 rate) and discharging at various C rates. Clearly, the carbon-coated electrode shows higher rate capability than the bare electrode. FIG. 20C compares the cycling performances of the bare and carbon-coated electrodes at a high rate (2C charge-discharge rate). While the bare sample delivers a capacity of about 114 mAh/g with a capacity retention of 90% in 30 cycles, the carbon-coated sample exhibit a capacity of about 150 mAh/g with a capacity retention of 98% in 30 cycles. The improved capacity retention is due to the suppression of the electrolyte attack by the carbon coating. FIG. 20D compares the EIS spectra of the bare and carbon-coated electrodes, with the equivalent circuit shown in the inset. Before the EIS measurement, both the samples were charged to 50% state of charge (SOC) to reach an identical status. Both the EIS spectra show two semicircles and one slope. The semicircles in the high and medium-to-low frequency regions correspond, respectively, to lithium-ion diffusion through the surface layer and charge transfer reaction, with the diameter of the semicircles giving the Rₛ and R_{ct} values (see caption to FIG. 20), while the slope in the low frequency region refers to lithium-ion diffusion in the bulk material. As seen, carbon coating decreases both Rₛ and R_{ct}, indicating an enhancement in the kinetics of lithium ion diffusion through surface layer and charge transfer reaction and a consequent increase in rate capability. The carbon coating decreases Rₛ by reducing the SEI layer thickness due to a suppressed interaction between the cathode surface and the electrolyte while maintaining a micro-porous structure, allowing lithium-ions to diffuse through. The improved surface electronic conductivity and the reduced SEI layer thickness decrease Rd.

Conductive carbon coating on the layered Li[Li_{0.2}Mn_{0.54}Ni_{0.13}Co_{0.13}]O₂ electrodes has been realized by a thermal evaporation process. The carbon-coated Li[Li_{0.2}Mn_{0.54}Ni_{0.13}Co_{0.13}]O₂ electrodes exhibit much enhanced rate capability and high rate cycling performance compared to the bare sample. Four-point conductivity and EIS measurements reveal that the improved electrochemical performance of the carbon-coated sample is due to the enhancement in surface electronic conductivity and the suppression of SEI layer development.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB.

Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

1. Z. Lu, L. Y. Beaulieu, R. A. Donaberger, C. L. Thomas and J. R. Dahn, J. Electrochem. Soc., 2002, 149, A778.
2. S. H. Kang, Y. K. Sun and K. Amine, Electrochem. Solid-State Lett., 2003, 6, A183.
3. Y. J. Park, Y. S. Hong, X. Wu, K. S. Ryu and S. H. Chang, J. Power Sources, 2004, 129, 288.
4. S. H. Kang and K. Amine, J. Power Sources, 2003, 124, 533.
5. D. A. R. Barkhouse and J. R. Dahn, J. Electrochem. Soc., 2005, 152, A746.
6. J. Jiang, K. W. Eberman, L. J. Krause and J. R. Dahn, J. Electrochem. Soc., 2005, 152, A1879.
7. T. A. Arunkumar, Y. Wu and A. Manthiram, Chem. Mater., 2007, 19, 3067.
8. Y. Wu and A. Manthiram, J. Power Sources, 2008, 183, 749.
9. Z. H. Lu and J. R. Dahn, J. Electrochem. Soc., 2002, 149, A815.
10. R. Armstrong, M. Holzapfel, P. Novak, C. S. Johnson, S.-H. Kang, M. M. Thackeray and P. G. Bruce, J. Am. Chem. Soc., 2006, 128, 8694.
11. M. M. Thackeray, S.-H. Kang, C. S. Johnson, J. T. Vaughey, R. Benedek and S. A. Hackney, J. Mater. Chem., 2007, 17, 3112.
12. Y. Wu and A. Manthiram, Electrochem. Solid-State Lett., 2006, 9, A221.
13. J. Liu and A. Manthiram, Chem. Mater., 2009, 21, 1695.
14. Y. Wu and A. Manthiram, J. Electrochem. Soc., 2008, 155, A635.
15. J. Liu and A. Manthiram, J. Electrochem. Soc., 2009, 156, A66.
16. H. J. Kweon, J. Park, J. W. Seo, G. Kim, B. Jung and H. S. Lim, J. Power Sources, 2004, 126, 156.
17. J. Cho, C. S. Kim and S. I. Yoo, Electrochem. Solid-State Lett., 2000, 3, 362.
18. Y. J. Kim, T. J. Kim, J. W. Shin, B. Park and J. Cho, J. Electrochem. Soc., 2002, 149, A1337.
19. J. Cho, Y. J. Kim, T. J. Kim and B. Park, Angew. Chem. Int. Ed., 2001, 40, 3367.
20. J. Cho, Electrochem. Commun., 2003, 5, 146.
21. H. Huang, S. C. Yin and L. F. Nazar, Electrochem. Solid-State Lett., 2001, 4, A170.
22. Z. H. Chen and J. R. Dahn, J. Electrochem. Soc., 2002, 149, A1184.
23. Y. S. Hu, Y. G. Guo, R. Dominko, M. Gaberscek, J. Jamnik and J. Maier, Adv. Mater., 2007, 19, 1963.
24. Q. Y. Wang, J. Liu, A. V. Murugan and A. Manthiram, J. Mater. Chem., 2009, 19, 4965.
25. M. D. Johannes, A. M. Stux and K. E. Swider-Lyons, Phys. Review B., 2008, 77, 075124.
26. J. Liu, Y. Yang, P. Yu, Y. Li and H. Shao, J. Power Sources, 2006, 161, 1435.
27. A. T. Appapillai, A. N. Mansour, J. Cho and S. H. Yang, Chem. Mater., 2007, 19, 5748.
28. S. T. Myung, N. Kumagai, S. Komaba and H. T. Chung, Solid State Ionics, 2001, 139, 47.
29. A. Iembo, F. Fuso, E. Arimondo, C. Ciofi, G. Pennelli, G. M. Curro, F. Neri, M. Allegrini, J. Mater. Res., 1997, 12, 1433.
30. Z. Y. Sun, Z. M. Liu, B. X. Han, S. D. Miao, J. M. Du and Z. J. Miao, Carbon, 2006, 44, 888.
31. D. W. Murphy, F. J. DiSalvo, J. N. Carides and J. V. Wasczak, Mater. Res. Bull., 1978, 13, 1395.
32. M. Armand, F. Dalard, D. Deroo and C. Mouliom, Solid State Ionics, 1985, 15, 205.
33. T. Ohzuku, K. Sawai and T. Hirai, J. Electrochem. Soc., 1990, 137, 3004.
34. K. Xu, Chem. Rev., 2004, 104, 4303.
35. A. M. Anderson and K. Edstrom, J. Electrochem. Soc., 2001, 148, A1100.
36. M. Lu, H. Cheng and Y. Yang, Electrochim. Acta, 2008, 53, 3539.
37. J. Liu and A. Manthiram, J. Phys. Chem. C, 2009, 113, 15073.
38. J. Liu and A. Manthiram, J. Electrochem. Soc., 2009, 156, A833.

1-20. (canceled)

21. A surface modified cathode comprising:
a lithium-excess cathode substrate composed of Li[M_{1-y}Li_{y}]O₂, where M is Mn, Co, Ni, or combinations thereof, and wherein 0<y≦0.33;
a surface modification layer coating the lithium-excess cathode substrate, the surface modification layer comprising Al₂O₃, RuO₂ or a combination thereof.

22. The cathode of claim 21, wherein the surface modification layer is composed of Al₂O₃.

23. The cathode of claim 21, wherein the surface modification layer is composed of RuO₂.

24. The cathode of claim 21, wherein the surface modification layer comprises a combination of Al₂O₃ and RuO₂.

25. The cathode of claim 21, wherein the surface modification layer comprises a combination of Al₂O₃ and RuO₂, where the wt. % ratio of Al₂O₃ to RuO₂ is about 1:1.

26. The cathode of claim 21, wherein the surface modification layer comprises between about 0.5 wt. % to about 10 wt. % of the cathode.

27. The cathode of claim 21, wherein the surface modification layer comprises between about 1 wt. % to about 2 wt. % of the cathode.

28. The cathode of claim 21, wherein the surface modification layer has a thickness of between about 2 to about 4 nm.

29. A surface modified cathode comprising:
a lithium-excess cathode substrate composed of Li[M_{1-y}Li_{y}]O₂, where M is Mn, Co, Ni, or combinations thereof, and wherein 0<y≦0.33;
a surface modification layer coating the lithium-excess cathode substrate, the surface modification layer comprising aluminum.

30. The cathode of claim 29, wherein the surface modification layer is a metallic aluminum film.

31. The cathode of claim 29, wherein the surface modification layer is a thermally evaporated film of metallic aluminum.

32. The cathode of claim 29, wherein the surface modification layer has a thickness of between 0.1 nm to 100 nm.

33. A surface modified cathode comprising:
a lithium-excess cathode substrate composed of Li[M_{1-y}Li_{y}]O₂, where M is Mn, Co, Ni, or combinations thereof, and wherein 0<y≦0.33;
a surface modification layer coating the lithium-excess cathode substrate, the surface modification layer comprising carbon.

34. The cathode of claim 33, wherein the surface modification layer is a thermally evaporated film of carbon.

35. The cathode of claim 33, wherein the surface modification layer has a thickness of between 0.1 nm to 100 nm.
